(19) United States
(12) Patent Application Publication
(10) Pub. No.: US 2026/0092895 A1
(43) Pub. Date: Apr. 2, 2026

(54) IN-SITU RAPID EDDY CURRENT TESTING METHOD FOR TRAILING EDGES OF AIRCRAFT ENGINE BLADES

(71) Applicant: Eddysun (Xiamen) Electronics Co., Ltd., Xiamen (CN)

(72) Inventors: Junming Lin, Xiamen (CN); Weihua Lin, Xiamen (CN); Zesen Lin, Xiamen (CN); Yating Wang, Xiamen (CN)

(21) Appl. No.: 19/344,996

(22) Filed: Sep. 30, 2025

(30) Foreign Application Priority Data
Sep. 30, 2024 (CN) 202411387288.2

(51) Int. Cl. G01N 27/90; F01D 21/00; G01N 27/9093

(52) U.S. Cl. CPC G01N 27/9006; F01D 21/003; G01N 27/9093; F05D 2260/83

(57) ABSTRACT

The present disclosure relates to eddy current detection technologies and discloses an in-situ rapid eddy current testing method for trailing edges of aircraft engine blades. The method utilizes a specially engineered elastic array eddy current sensor buckled to a fixed ring of an engine wheel. By rotating the engine wheel, a single-pass scan simultaneously inspects the trailing edges of tens to hundreds of the aircraft engine blades. Compared to conventional methods utilizing a single conformal probe manually traversed along the trailing edges, the present disclosure greatly improves the detection efficiency and has higher detection sensitivity.

### RELATED APPLICATIONS

This application claims priority to Chinese patent application number 202411387288.2, filed on September 30, 2024. Chinese patent application number 202411387288.2 is incorporated herein by reference.

### FIELD OF THE DISCLOSURE

The present disclosure relates to the field of nondestructive testing technologies, and more particularly, to an in-situ rapid eddy current testing method for trailing edges of aircraft engine blades.

### BACKGROUND OF THE DISCLOSURE

Aero engines are critical components indispensable to modern aircraft. Operating under extreme conditions of high-temperature, high-speed, and high-pressure environments, particularly in military applications, engine blades are highly susceptible to fatigue crack formation. Consequently, nondestructive testing of aero engines has been widely implemented globally, with a focus on inspecting blade components, the most vulnerable structural elements. Both borescope inspections and eddy current testing are employed for in-situ periodic or condition-based inspections of these blades, with standardized protocols established even for commercial aviation. Among existing methods, eddy current testing has proven most reliable and practical. Conventional practice utilizes a dedicated conformal eddy current probe manually traversed along the blade trailing edge once or twice to detect discontinuity defects. However, this approach suffers from inefficiency, necessitating the development of expedited detection techniques to meet advancing technological demands.

### BRIEF SUMMARY OF THE DISCLOSURE

In order to solve the above technical problems, the present disclosure provides an in-situ rapid eddy current testing method for trailing edges of aircraft engine blades comprising the following steps:

(1) providing an eddy current testing sensor, wherein:

the eddy current testing sensor comprises a hollow housing, a plurality of elastic detection belts, a high-density sponge layer, and a fixed buckling base;

the hollow housing is configured to have a rectangular parallelepiped shape with an open cavity;

each of the plurality of elastic detection belts is respectively fixedly disposed on two long sides of the open cavity of the hollow housing, a middle of each of the plurality of elastic detection belts comprises a detection area, and the plurality of elastic detection belts are equidistantly arranged;

the detection area comprises a flexible contoured elastic piece and a contoured eddy current testing coil, and the contoured eddy current testing coil is fixedly disposed on a surface of the flexible contoured elastic piece;

the high-density sponge layer is encapsulated and filled in the hollow housing;

the detection areas of the plurality of elastic detection belts are distributed at different positions to form an eddy current array testing channel, an eddy current array testing channel is configured to conform to each of the trailing edges of the aircraft engine blades through an elastic recovery function of the high-density sponge layer, and the fixed buckling base is disposed on a side surface of the hollow housing;

(2) mounting the eddy current testing sensor by fixedly mounting the eddy current testing sensor of the step (1) on a fixed ring of an engine wheel to be detected through the fixed buckling base, so that the eddy current array testing channel is configured to abut each of the trailing edges of the aircraft engine blades of an engine to be detected; and

(3) performing rotational detection by manually or by using an external transmission device rotating the engine wheel to be detected, so that all of the aircraft engine blades on the engine wheel to be detected rotate one circle relative to the eddy current testing sensor, and scanning the trailing edges of all of the aircraft engine blades using the eddy current testing sensor to obtain eddy current detection signals of the trailing edges of all of the aircraft engine blades on the engine wheel, so that a three-dimensional imaging diagram of an eddy current array is formed.

Furthermore, in the step (1), the fixed buckling base comprises two buckling connection parts.

Furthermore, the contoured eddy current testing coil adopts a high-frequency, multi-frequency excitation mode.

Furthermore, the step (3) further comprises pre-establishing an inversion imaging model by obtaining eddy current detection signal datasets of each of the trailing edges of the aircraft engine blades to form a three-dimensional imaging image of each of the aircraft engine blades, and generating a three-dimensional imaging image of the engine wheel.

Compared with the existing techniques, the technical solution has the following advantages.

The present disclosure employs a specially designed eddy current testing sensor, wherein a plurality of elastic detection belts, which are independently actuatable, are disposed on the open cavity of a hollow housing. The plurality of elastic detection belts comprise the detection areas positioned at varying locations. Coupled with the elastic compression provided by the high-density sponge layer, this configuration enables conformal contact between the eddy current testing sensor and the trailing edges of the turbine blades. The eddy current testing sensor is buckled to a fixed ring of the engine wheel. By rotating the engine wheel, a single-pass scan simultaneously inspects the trailing edges of tens to hundreds of the turbine blades. Compared to conventional methods utilizing a single conformal probe manually traversed along the trailing edges, the present disclosure greatly improves the detection efficiency and has higher detection sensitivity.

### BRIEF DESCRIPTION OF THE DRAWINGS

To clarify technical solutions in the embodiments of the present disclosure or the existing techniques, the following provides a concise introduction to the accompanying drawings. It will be apparent to those skilled in the art that additional drawings may be derived from these figures without inventive effort.

FIG. 1 is a schematic diagram of a testing method according to the present disclosure.

FIG. 2 is a structural illustration of an eddy current testing sensor viewed from a bottom-up perspective.

FIG. 3 is an overall configuration of the eddy current testing sensor.

### Numerical References in Drawings:

10: Engine wheel, 11: Aircraft engine blade;

20: Eddy current detection sensor, 21: Hollow housing, 22: Elastic detection belt, and 23: fixed buckling base;

221: Detection area, 221a: flexible contoured elastic piece, and 221b: contoured eddy current testing coil.

### DETAILED DESCRIPTION OF THE EMBODIMENTS

To make the objectives, technical solutions, and advantages of the embodiments more comprehensible, the present disclosure is further described below with reference to the accompanying drawings. The described embodiments represent selected implementations of the invention and are not exhaustive. Consequently, the detailed descriptions of embodiments provided herein are not intended to limit the scope of the present disclosure but merely illustrate preferred modes of practice.

A structural design of trailing edges of engine blades, particularly turbine blades in gas dynamics applications, critically influences an aerodynamic performance and exhaust efficiency of the turbine blades. This necessitates comprehensive consideration of blade geometry, trailing edge curvature, twist angle, and related parameters during the design phase. The irregular and complex geometry of blade structures of the turbine blades presents significant challenges to the development of corresponding inspection sensors and the execution of detection processes. Conventional methods predominantly rely on a single contoured eddy current probe manually traversed along the trailing edge for scanning. However, this approach suffers from markedly low detection efficiency and imposes stringent demands on operator expertise. While some researchers have explored eddy current array structures for trailing edge inspection, planar eddy current array structures inherently fail to achieve effective contact with the trailing edges during detection. Based on this, the present disclosure conducts technical research, and a specific implementation is described as below.

An in-situ rapid eddy current testing method for the trailing edges of aircraft engine blades comprises the following steps.

### 1 Designing an eddy current testing sensor 20

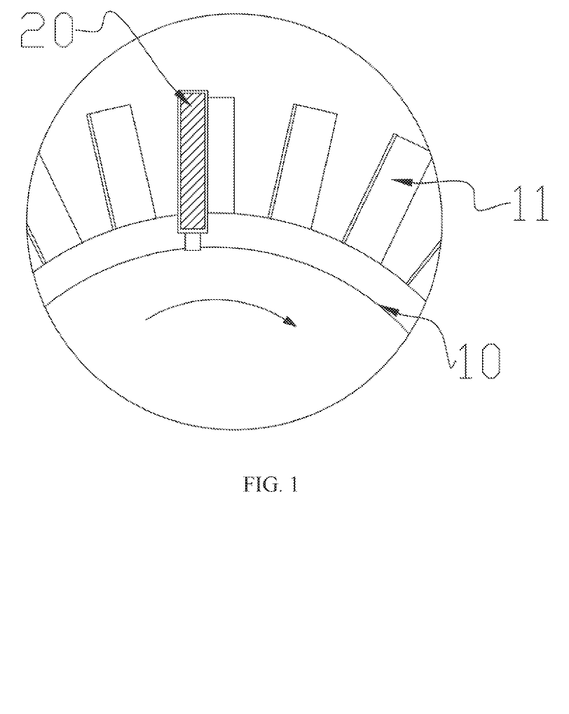

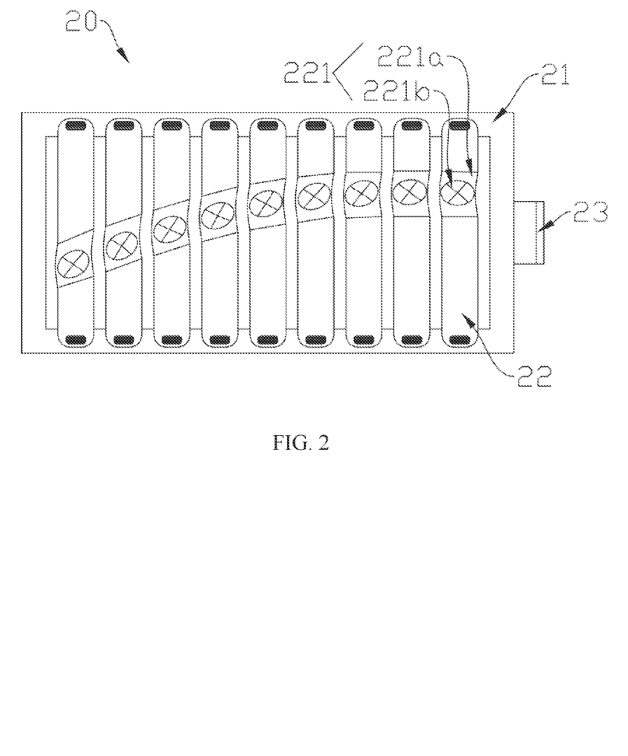

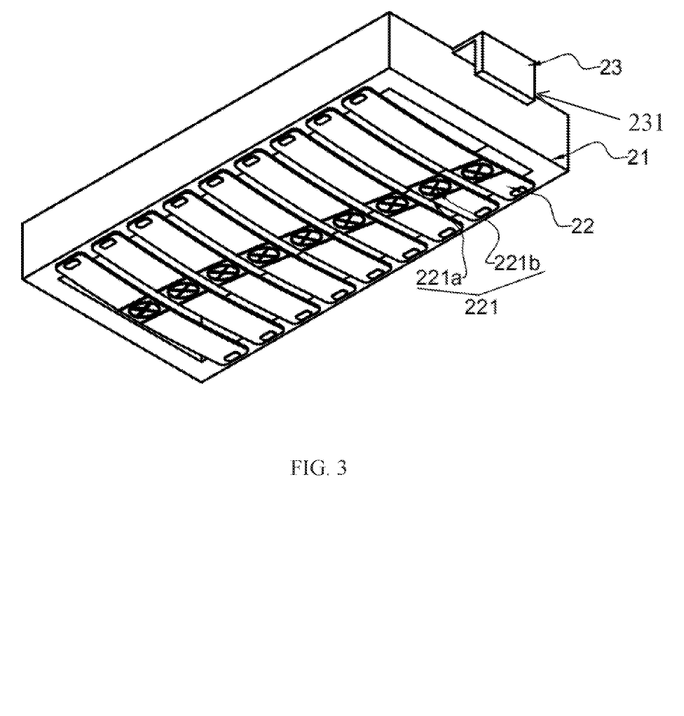

Referring to FIGS. 1-3, the eddy current testing sensor 20 comprises a hollow housing 21, a plurality of elastic detection belts 22, a high-density sponge layer (not shown in the figures), and a fixed buckling base 23.

The hollow housing 21 is configured to have a rectangular parallelepiped shape with an open cavity.

Each of the plurality of elastic detection belts 22 is respectively fixedly disposed on two long sides of the open cavity of the hollow housing 21, and a middle of each of the plurality of elastic detection belts 22 comprises a detection area 221. The plurality of elastic detection belts 22 are equidistantly arranged. That is, each of the plurality of elastic detection belts 22 can be deformed independently. Compared with the existing method of using flexible array eddy current detection, a design of the plurality of elastic detection belts 22 improves freedom of movement of the eddy current testing sensor 20, can better fit each of the trailing edges of the turbine blades with different curvatures and large torsion angles, and improves the detection sensitivity.

The detection area 221 comprises a flexible contoured elastic piece 221a and a contoured eddy current testing coil 221b. The contoured eddy current testing coil 221b is fixedly disposed on a surface of the flexible contoured elastic piece 221a. The flexible contoured elastic piece 221a can both provide support for the contoured eddy current testing coil 221b and protect the contoured eddy current testing coil 221b so as to prevent the contoured eddy current testing coil 221b from being over-pressed. In this embodiment, the surface of the flexible contoured elastic piece 221a is also sealed with a flexible wear-resistant layer to protect the contoured eddy current testing coil 221b.

The high-density sponge layer is encapsulated and filled in the hollow housing 21. The high-density sponge layer has good support and resilience, so that the detection area 221 of each of the plurality of elastic detection belts 22 closely abuts each of the trailing edges of the turbine blades to be detected.

The detection areas 221 of the plurality of elastic detection belts 22 are distributed at different positions, and through an elastic recovery function of the high-density sponge layer, an eddy current array testing channel is formed and is configured to conform to each of the trailing edges of the turbine blades (i.e., aircraft engine blades 11) to be detected.

The fixed buckling base 23 is disposed on a side surface of the hollow housing 21, and in this embodiment, the fixed buckling base 23 is disposed on an outer side wall of a short side of the hollow housing 21.

### 2 Mounting the eddy current testing sensor 20

The eddy current testing sensor 20 of step (1) is fixedly mounted on a fixed ring of an engine wheel 10 to be detected through the fixed buckling base 23, so that the eddy current array testing channel is configured to abut each of the trailing edges of the aircraft engine blades 11 of the engine to be detected.

### 3 Rotation detection

The engine wheel 10 to be detected is rotated manually or by using an external transmission device, so that all of the aircraft engine blades 11 on the engine wheel 10 to be detected rotate one circle (i.e., 360°) relative to the eddy current testing sensor 20. The eddy current testing sensor 20 scans and obtains eddy current detection signals of the trailing edges of all of the aircraft engine blades 11 on the engine wheel 10, and the eddy current testing sensor 20 forms a three-dimensional imaging diagram of the eddy current array.

Furthermore, in step (1), the fixed buckling base 23 comprises two buckling connection parts 231. After the engine wheel 10 rotates one circle relative to the eddy current testing sensor 20 to complete a detection, the eddy current testing sensor 20 can be moved forward or backward to adjust a fixed position and perform a second rotation scan to ensure that the part to be detected is fully covered to prevent missed detection.

Furthermore, in step (1), the eddy current array testing channel realizes a three-dimensional array eddy current detection conforming to the trailing edges of the turbine blades. The contoured eddy current testing coil 221b adopts a high-frequency, multi-frequency excitation mode, and an excitation frequency of the contoured eddy current testing coil 221b on each of the plurality of elastic detection belts 22 is selected according to a specific curvature change. The use of high-frequency excitation in the eddy current testing can effectively detect tiny cracks, and the multi-parameter detection of a same part is performed by multi-frequency excitation, expanding the detection data and improving clarity of the three-dimensional scanning imaging map.

Furthermore, in step (3), an inversion imaging model can be pre-established to obtain eddy current detection signal datasets of each of the trailing edges of the turbine blades to form a three-dimensional imaging image of each of the turbine blades, and further generate a three-dimensional imaging image of the engine wheel 10 by an upper computer to achieve a comprehensive evaluation of the turbine blades on the engine wheel 10.

A computer can be used to establish a model of the engine wheel 10, and the inversion imaging model can be established by combining relevant parameters such as a blade structure, a wheel rotation speed, an eddy current detection speed, etc.

The above description is only a preferred embodiment of the present disclosure and is not intended to limit the present disclosure. For those skilled in the art, the present disclosure may have various modifications and variations. Any modification, equivalent replacement, improvement, etc. made within the spirit and principle of the present disclosure shall be included in the protection scope of the present disclosure.

What is claimed is:

1. An in-situ rapid eddy current testing method for trailing edges of aircraft engine blades comprising the following steps:
(1) providing an eddy current testing sensor, wherein:
the eddy current testing sensor comprises a hollow housing, a plurality of elastic detection belts, a high-density sponge layer, and a fixed buckling base,
the hollow housing is configured to have a rectangular parallelepiped shape with an open cavity,
each of the plurality of elastic detection belts is respectively fixedly disposed on two long sides of the open cavity of the hollow housing,
a middle of each of the plurality of elastic detection belts comprises a detection area,
the plurality of elastic detection belts are equidistantly arranged,
the detection area comprises a flexible contoured elastic piece and a contoured eddy current testing coil,
the contoured eddy current testing coil is fixedly disposed on a surface of the flexible contoured elastic piece,
the high-density sponge layer is encapsulated and filled in the hollow housing,
the detection areas of the plurality of elastic detection belts are distributed at different positions to form an eddy current array testing channel,
the eddy current array testing channel is configured to conform to each of the trailing edges of the aircraft engine blades through an elastic recovery function of the high-density sponge layer, and
the fixed buckling base is disposed on a side surface of the hollow housing;
(2) mounting the eddy current testing sensor by:
fixedly mounting the eddy current testing sensor of the step (1) on a fixed ring of an engine wheel to be detected through the fixed buckling base, so that the eddy current array testing channel is configured to abut each of the trailing edges of the aircraft engine blades of an engine to be detected; and
(3) performing rotational detection by:
manually or by using an external transmission device rotating the engine wheel to be detected, so that all of the aircraft engine blades on the engine wheel to be detected rotate one circle relative to the eddy current detection sensor,
scanning the trailing edges of all of the aircraft engine blades using the eddy current testing sensor to obtain eddy current detection signals of the trailing edges of all of the aircraft engine blades on the engine wheel, so that a three-dimensional imaging diagram of an eddy current array is formed.

2. The in-situ rapid eddy current testing method for the trailing edges of the aircraft engine blades according to claim 1, wherein:
in the step (1), the fixed buckling base comprises two buckling connection parts.

3. The in-situ rapid eddy current testing method for the trailing edges of the aircraft engine blades according to claim 1, wherein:
the contoured eddy current testing coil adopts a high-frequency, multi-frequency excitation mode.

4. The in-situ rapid eddy current testing method for the trailing edges of the aircraft engine blades according to claim 3, wherein the step (3) further comprises:
pre-establishing an inversion imaging model by:
obtaining eddy current detection signal datasets of each of the trailing edges of the aircraft engine blades to form a three-dimensional imaging image of each of the aircraft engine blades, and
generating a three-dimensional imaging image of the engine wheel.
